(19) United States
(12) Patent Application Publication
(10) Pub. No.: US 2023/0028499 A1
(43) Pub. Date: Jan. 26, 2023

(54) METHOD FOR MANAGING MOVING OBJECT AND APPARATUS FOR THE SAME

(71) Applicants: Hyundai Motor Company, Seoul (KR); Kia Corporation, Seoul (KR)

(72) Inventors: Jae Jun Ha, Hwaseong-si (KR); Young Jun Moon, Sejong-si (KR)

(21) Appl. No.: 17/807,978

(22) Filed: Jun. 21, 2022

(30) Foreign Application Priority Data
Jul. 26, 2021 (KR) 10-2021-0097879

(51) Int. Cl. B60W 30/16; B60W 40/08; B60W 60/00

(52) U.S. Cl. CPC B60W 30/16; B60W 40/08; B60W 60/0015; B60W 2540/221; B60W 2040/0872; B60W 2554/80; B60W 2510/30

(57) ABSTRACT

An embodiment method of controlling a moving object includes checking profile information of a user who rides in the moving object or status information of the user, checking a degree of risk based on the profile information or the status information of the user, setting an operation mode of the moving object based on the degree of risk, and controlling movement of the moving object based on the operation mode.

### CROSS-REFERENCE TO RELATED APPLICATIONS

This application claims the benefit of Korean Patent Application No. 10-2021-0097879, filed on Jul. 26, 2021, which application is hereby incorporated herein by reference.

### TECHNICAL FIELD

The present disclosure relates to a method of controlling a moving object and an apparatus for the same.

### BACKGROUND

Recently, with the development of advanced technology and the IT industry, interest in drones, electric vehicles and artificial intelligence is gradually increasing. In addition, much research into autonomous moving objects obtained by combining IT and automobile technologies has been conducted.

In general, an autonomous moving object refers to a moving object capable of autonomously traveling to a set destination by recognizing surrounding objects such as roads, vehicles, and pedestrians without manipulation of a driver.

Such an autonomous vehicle may autonomously travel to the set destination without manipulation of the driver and thus may be used as a moving object, in which multiple users ride, in a business complex or a smart town.

### SUMMARY

The present disclosure relates to a method of controlling a moving object and an apparatus for the same. Particular embodiments relate to a method and apparatus for controlling a moving object in which multiple users ride.

A moving object in which multiple users ride is used as a shuttle vehicle. A conventional shuttle vehicle having an autonomous function generally travels only on a predetermined route and cannot provide a personalized service to a plurality of users or a single user who rides in the shuttle vehicle.

An embodiment of the present disclosure provides a method and apparatus for managing a moving object according to individual situations or tendencies of users riding in the moving object in which multiple users ride.

According to an embodiment of the present disclosure, a user-based moving object control method is disclosed. The method may include checking at least one of profile information of a user who rides in the moving object or status information of the user, checking a degree of risk based on at least one of profile information or status information of the user, setting an operation mode of the moving object based on the degree of risk, and controlling movement of the moving object based on the operation mode.

The status information of the user may include whether the at least one user is seated or user location information in the moving object.

The profile information may include at least one of age, gender, health status, pregnancy status, disability status or personal setting information of the at least one user.

The operation mode of the moving object may include a value for controlling at least one of an acceleration/deceleration speed, a distance from a moving object traveling ahead, or a turning angle.

The checking the degree of risk may include checking the degree of risk of the user using the profile information of the user or the status information of the user.

The checking the degree of risk may include checking a highest degree of risk among degrees of risk of the user.

The checking the degree of risk may include checking a seated or standing state of the user and checking whether the user is mobility handicap.

The checking the degree of risk may include checking a type of mobility handicap of the user and checking a degree of risk suitable for the checked type of the mobility handicap, when the user is in the seated state. When the user is in the standing state, checking a type of the mobility handicap of the user and checking a degree of risk suitable for the checked type of the mobility handicap may be included.

The checking the type of the mobility handicap of the user may include checking the type of the mobility handicap of the user based on the profile information of the user.

The checking the degree of risk may include checking standing posture information of the user.

The checking the degree of risk may include determining the degree of risk by combining a degree of risk corresponding to the type of the mobility handicap of the user and a degree of risk corresponding to the standing posture information.

The checking the degree of risk may include adding the degree of risk corresponding to the type of the mobility handicap of the user and the degree of risk corresponding to the standing posture information.

The checking the degree of risk may include determining the degree of risk by giving a weight corresponding to the standing posture information to the degree of risk corresponding to the type of the mobility handicap of the user.

Controlling a riding environment of the moving object by considering the profile information of the at least one user may be included.

The checking the status information of the at least one user may include checking biometric information of the at least one user.

The riding environment of the moving object may include at least one of a seat posture setting value, a seat temperature setting value or an air conditioner setting value.

Checking loading information of cargo loaded on a cargo loading device provided in the moving object may be included.

The loading information of the cargo may include at least one of information indicating whether the cargo is loaded, information indicating whether the cargo is fixed, or information indicating density of the cargo loaded on the cargo loading device.

The checking the degree of risk may include checking a degree of risk of the cargo by considering the loading information of the cargo.

The checking the degree of risk may include determining a final degree of risk by considering the degree of risk of the user and the degree of risk of the cargo.

Checking loading state information of a personal mobility and providing loading state information of the personal mobility to at least one preliminary user who will ride in the moving object may be included.

Providing the loading information of the cargo to the at least one preliminary user who will ride in the moving object may be included.

According to another embodiment of the present disclosure, a moving object control system may be provided. The moving object control system may include a server apparatus configured to provide a moving object operation service and to manage at least one of profile information of a user who uses the moving object operation service, usage information of the user, location information of a moving object, or usage status information of the moving object, the moving object being configured to check an operation mode of the moving object based on at least one of the profile information of the user, the usage information of the user, or status information of the user and to control movement based on the operation mode, and a user device connected to the server apparatus to input and output information required to use the moving object operation service.

The moving object may control a riding environment of the moving object by considering the profile information of the user.

The moving object may check biometric information of the user and control the riding environment of the moving object by considering the profile information of the user.

The riding environment of the moving object may include at least one of a seat posture setting value, a seat temperature setting value, or an air conditioner setting value.

According to another embodiment of the present disclosure, a moving object may be provided. The moving object may include a communication unit, at least one storage medium, and at least one processor. The at least one processor may check at least one of profile information of a user who rides in the moving object or status information of the user, check a degree of risk based on at least one of profile information or status information of the user, set an operation mode of the moving object based on the degree of risk, and control movement of the moving object based on the operation mode.

The at least one processor may control a riding environment of the moving object by considering the profile information of the user.

The at least one processor may check biometric information of the user and control the riding environment of the moving object by considering the biometric information of the user.

The riding environment of the moving object may include at least one of a seat posture setting value, a seat temperature setting value, or an air conditioner setting value.

A cargo loading device configured to load or fix cargo may be provided.

The at least one processor may check at least one of information indicating whether the cargo is loaded, information indicating whether the cargo is fixed, or information indicating density of the cargo loaded on the cargo loading device, and check the degree of risk based on the checked at least one information.

The at least one processor may determine a final degree of risk by considering the degree of risk of the user and the degree of risk of the cargo.

A personal mobility loading device configured to mount or fix a personal mobility may be further included, and at least one processor may check loading state information of the personal mobility including whether the personal mobility is loaded on the personal mobility loading device.

The at least one processor may provide the loading state information of the personal mobility to a server apparatus provided in the moving object operation system or a user device provided in the moving object operation system.

The operation mode of the moving object may include a value for controlling at least one of an acceleration/deceleration speed, a distance from a moving object traveling ahead, or a turning angle.

The at least one processor may check the degree of risk of the user using the profile information of the user or the status information of the user.

The at least one processor may check a highest degree of risk among degrees of risk of the user.

The at least one processor may check a seated or standing state of the user and check the degree of risk of the user based on the seated or standing state of the user.

The at least one processor may check a type of mobility handicap of the user and check a degree of risk suitable for the checked type of the mobility handicap, when the user is in the seated state.

The at least one processor may check a type of the mobility handicap of the user and check a degree of risk suitable for the checked type of the mobility handicap, when the user is in the standing state.

The at least one processor may check the type of the mobility handicap of the user based on the profile information of the user.

The at least one processor may check at least one of a degree of risk corresponding to the type of the mobility handicap of the user or a degree of risk corresponding to the standing posture information and determine the degree of risk by combining the at least one degree of risk.

According to another embodiment of the present disclosure, a server apparatus may be provided. The server apparatus may include a communication unit, at least one storage medium, and at least one processor. The at least one processor may be connected to a moving object provided in a moving object operation system and a user device to provide a moving object operation service and to manage at least one of profile information of a user who uses the moving object operation service, usage information of the user, location information of the moving object, or usage status information of the moving object.

A personal mobility loading device configured to mount or fix a personal mobility in the moving object may be provided, and the at least one processor may receive loading state information of a personal mobility including whether to load the personal mobility on the personal mobility loading device and provide loading state information of the personal mobility to the user device.

The at least one processor may check a degree of risk of the user using the profile information of the user or the status information of the user received from the moving object and provide the checked degree of risk of the user to the moving object.

The at least one processor may check a highest degree of risk among degrees of risk of the user who rides in the moving object.

The at least one processor may check a seated or standing state of the user received from the moving object and check the degree of risk of the user based on the seated or standing state of the user.

The at least one processor may check a type of mobility handicap of the user based on the profile information of the user and check a degree of risk suitable for the checked type of the mobility handicap.

According to embodiments of the present disclosure, it is possible to provide a service for operating a moving object in which multiple users ride.

According to embodiments of the present disclosure, it is possible to provide a method of setting an operating environment of a moving object according to a user who rides in the moving object when providing a moving object operation service.

According to embodiments of the present disclosure, it is possible to more safely control operation of an autonomous moving object by setting an operating environment according to a user who rides in a moving object.

### BRIEF DESCRIPTION OF THE DRAWINGS

FIG. 1A is a view illustrating a network environment of an entity provided in a user-based moving object operation system according to an embodiment of the present disclosure.

FIG. 1B is a view illustrating a moving object used in a user-based moving object operation system according to an embodiment of the present disclosure.

FIG. 1C is a view illustrating a shuttle vehicle controlled by a method of using the shuttle vehicle according to an embodiment of the present disclosure.

FIG. 2 is a view illustrating a user-based moving object operation system according to an embodiment of the present disclosure.

FIG. 3 is a view illustrating a method of using a shuttle vehicle according to an embodiment of the present disclosure.

FIG. 4 is a flowchart illustrating a method of controlling a shuttle vehicle based on user according to an embodiment of the present disclosure.

FIG. 5 is a view illustrating an operation mode according to a degree of risk used in a method of controlling a shuttle vehicle based on a user according to an embodiment of the present disclosure.

FIGS. 6A and 6B are views illustrating a degree of risk determined according to a loading state of cargo used in a method of controlling a user-based shuttle vehicle according to an embodiment of the present disclosure.

FIG. 7 is a flowchart illustrating detailed operation of step S450 of FIG. 4.

FIGS. 8A and 8B are tables showing a degree of risk according to the mobility handicap used in a method of controlling a shuttle vehicle based on a user according to an embodiment of the present disclosure.

FIG. 9 is a table showing a degree of risk of cargo according to an object loading ratio used in a method of controlling a shuttle vehicle based on a user according to an embodiment of the present disclosure.

FIG. 10 is a view illustrating the configuration of an apparatus according to an embodiment of the present disclosure.

### DETAILED DESCRIPTION OF ILLUSTRATIVE EMBODIMENTS

Hereinafter, embodiments of the present disclosure will be described in detail with reference to the accompanying drawings, which will be easily implemented by those skilled in the art. However, the present disclosure may be embodied in many different forms and is not limited to the embodiments described herein.

In the following description of the embodiments of the present disclosure, a detailed description of known functions and configurations incorporated herein will be omitted when it may make the subject matter of the present disclosure rather unclear. Parts not related to the description of embodiments of the present disclosure in the drawings are omitted, and like parts are denoted by similar reference numerals.

In embodiments of the present disclosure, when a component is referred to as being “linked”, “coupled”, or “connected” to another component, it is understood that not only a direct connection relationship but also an indirect connection relationship through an intermediate component may also be included. Also, when a component is referred to as “comprising” or “having” another component, it may mean further inclusion of another component not the exclusion thereof, unless explicitly described to the contrary.

In embodiments of the present disclosure, the terms first, second, etc. are used only for the purpose of distinguishing one component from another, and do not limit the order or importance of components, etc. unless specifically stated otherwise. Thus, within the scope of this disclosure, a first component in one exemplary embodiment may be referred to as a second component in another embodiment, and similarly a second component in one exemplary embodiment may be referred to as a first component in another embodiment.

In embodiments of the present disclosure, components that are distinguished from each other are intended to clearly illustrate each feature. However, it does not necessarily mean that the components are separate. That is, a plurality of components may be integrated into one hardware or software unit, or a single component may be distributed into a plurality of hardware or software units. Thus, unless otherwise noted, such integrated or distributed embodiments are also included within the scope of the present disclosure.

In embodiments of the present disclosure, components described in the various exemplary embodiments are not necessarily essential components, and some may be optional components. Accordingly, exemplary embodiments consisting of a subset of the components described in one embodiment are also included within the scope of the present disclosure. Also, exemplary embodiments that include other components in addition to the components described in the various embodiments are also included in the scope of the present disclosure.

Advantages and features of embodiments of the present disclosure, and methods for achieving them will be apparent with reference to the exemplary embodiments described below in detail with reference to the accompanying drawings. However, the present disclosure is not limited to the exemplary embodiments set forth herein but may be embodied in many different forms. The present exemplary embodiments are provided to make disclosed contents of the present disclosure thorough and complete and to completely convey the scope of the disclosure to those with ordinary skill in the art.

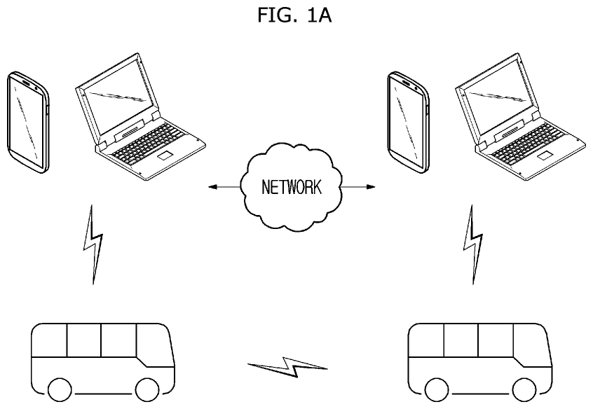

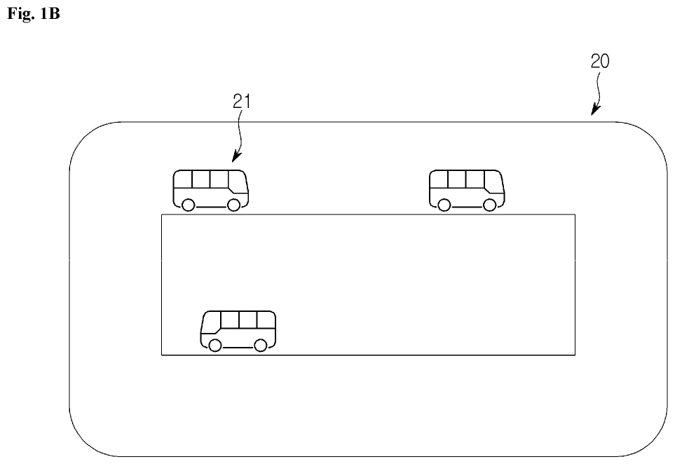

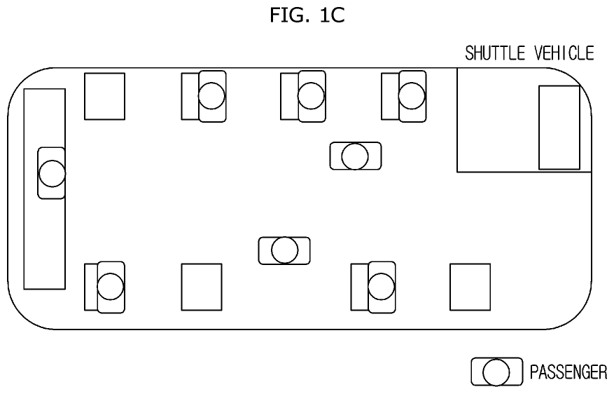

FIG. 1A is a view illustrating a network environment of an entity provided in a user-based moving object operation system according to an embodiment of the present disclosure.

For example, referring to FIG. 1A, a moving object may perform communication with another moving object or another device. In this case, for example, the moving object may perform communication with another moving object or another device based on cellular communication, WAVE communication or another communication method. That is, the moving object may include a device capable of performing communication and may perform communication with another device based on this.

In addition, for example, in relation to communication of the moving object, for security of the moving object, a module capable of performing communication with only a device located inside the moving object and a module capable of performing communication with a device located outside the moving object may be separately provided. For example, in the moving object, communication with a device within a certain range of the moving object, such as UWB communication, may be performed based on security. For example, each of the moving object and a user's private device may include a communication module for performing only mutual communication. That is, the moving object and the user's private device may use a communication network disconnected from an external communication network. In addition, for example, the moving object may include a communication module for performing communication with an external device. Furthermore, in an embodiment of the present disclosure, the moving object may include a shuttle vehicle in which multiple users simultaneously ride. Although the moving object is a shuttle vehicle in an embodiment of the present disclosure, the present disclosure is not limited thereto and various modifications are possible.

FIG. 1B is a view illustrating a moving object used in a user-based moving object operation system according to an embodiment of the present disclosure.

Referring to FIG. 1B, a moving object 21 may be a shuttle vehicle traveling in a certain area 20.

For example, the shuttle vehicle 21 may be a shuttle which operates based on an autonomous driving method. The shuttle vehicle 21 may be a shuttle which operates based on fully autonomous driving. As another example, the shuttle vehicle 21 may be a shuttle in which some autonomous driving technologies are implemented. More specifically, the shuttle vehicle 21 may be a shuttle vehicle or a moving object which operates based on an autonomous driving function, and an autonomous driving degree may vary. For example, the autonomous driving degree may be represented by a level or class. The shuttle vehicle which operates based on fully autonomous driving may be represented by a highest level or class. In addition, for example, a level or class which varies according to the autonomous driving degree may be represented. In the following description, it may apply not only to a fully autonomous driving shuttle vehicle, all operations of which are controlled, but also to an autonomous vehicle partially performing an autonomous driving function. However, in the following description, the shuttle vehicle is used for convenience of description and it is applicable to a fully autonomous driving shuttle vehicle and a partial autonomous driving shuttle vehicle.

In this case, for example, a guide line may be a visually recognized line. For example, the guide line may be a line visually installed on a road to be recognized by the shuttle vehicle and may be made of magnetic or fluorescent material. As another example, the guide line may be a non-visual line. For example, the guide line may not be installed on a road and may be virtually set along a movement route. That is, the guide line may be a line set to be recognized by the shuttle vehicle without being visually recognized. For example, the guide line may be a virtual line indicated by a road side unit (RSU), a peripheral device, a base station, or a server located on a movement route on which the shuttle vehicle travels. That is, the peripheral devices may provide a virtual guide line such that the shuttle vehicle travels on the movement route, and the shuttle vehicle operates based on this.

As another example, the guide line may be generated based on at least one of a movement route, a traveling direction of a shuttle vehicle or surrounding information. That is, the guide line is generated in a specific case in consideration of driving of the shuttle vehicle and may be set to disappear when driving is completed.

In addition, for example, the shuttle vehicle 21 may be a shuttle controlled by a central server in consideration of the case of being operated in the certain area 20. That is, the shuttle vehicle 21 may be a device capable of providing a user with a function as a shuttle based on authentication, identification and security functions, and is not limited to the above-described embodiment.

As another example, the shuttle vehicle 21 may operate based on a map. In this case, for example, the map used by the shuttle vehicle 21 may be a multi-map and various types of maps may be used. For example, the multi-map may be a map related to operation of the shuttle vehicle and a map for other driving. In addition, the multi-map may include a map for not only a driving area of a shuttle vehicle but also a three-dimensional map, and is not limited to the above-described embodiment. Here, the map used by the shuttle vehicle 21 may be received from the central server or stored in and managed by a storage medium provided in the shuttle vehicle 21. As another example, the shuttle vehicle 21 may periodically receive data from the central server and update the map stored in the storage medium by considering the received data.

In addition, for example, the shuttle vehicle 21 may perform communication with a road side unit (RSU) and control operation based on this. In this case, for example, the RSU may be a device capable of performing communication with a shuttle (or shuttle vehicle) disposed periodically or at a certain distance on a road. In addition, for example, the RSU may refer to a device disposed at a specific point on a road to communicate with a shuttle (or a shuttle vehicle). As another example, the RSU may refer to a terminal capable of communication as a traffic infrastructure. As another example, the RSU may refer to a device capable of performing communication with the shuttle vehicle as a V2X terminal, a surrounding shuttle vehicle, a surrounding shuttle or other moving object. That is, the RSU refers to a device capable of performing communication with an autonomous driving shuttle vehicle in the vicinity of the shuttle vehicle. Hereinafter, for convenience of description, the RSU will be described. In this case, for example, the shuttle vehicle 21 may receive operation related information from the RSU. In addition, the shuttle vehicle 21 may receive other information from the RSU in addition to the operation related information and is not limited to the above-described embodiment. As another example, the shuttle vehicle 21 may receive operation related information from the RSU based on a predetermined period. In this case, a plurality of RSUs may transmit operation related information to the shuttle vehicle 21. For example, operation related information may be received from an adjacent RSU according to driving of the shuttle vehicle 21. In addition, for example, the shuttle vehicle 21 may receive operation related information from the RSU based on event triggering. More specifically, the shuttle vehicle 21 may receive operation related information from the RSU to obtain information necessary to detect a specific situation or an instruction of a user (driver). For example, the specific situation may be a case where the shuttle vehicle deviates from a guide line or a movement route and is not limited to the above-described embodiment. That is, the autonomous driving shuttle vehicle may receive related information from the RSU and is not limited to the above-described embodiment.

In addition, for example, the guide line may be installed based on various routes in a certain area. For example, the shuttle vehicle 21 may operate in an area in which the guide line is installed as a plurality of routes. That is, there may be a plurality of routes on which the shuttle vehicle 21 operates. For example, the guide line may be set in various directions at the intersection. In addition, the guide line may be set to a plurality of routes in relation to movement of the autonomous driving shuttle. Meanwhile, for example, in relation to the guide line, autonomous shuttle route information may be calculated based on the number of possible routes and intersections and may be stored in the autonomous driving shuttle or server. In addition, the autonomous driving shuttle or server may recognize the guide line based on the route, which will be described below. That is, the autonomous driving shuttle vehicle may travel along a predetermined route while traveling along the guide line and operate in a predetermined area.

FIG. 1C is a view illustrating a shuttle vehicle controlled by a method of using the shuttle vehicle according to an embodiment of the present disclosure. More specifically, FIG. 1C illustrates the location of multiple passengers in a shuttle vehicle.

Next, a specific method of driving a shuttle vehicle may be considered. For example, the shuttle vehicle may receive information for driving from a personal device or server and operate based on this. More specifically, the shuttle vehicle may receive at least one of start location information, end location information, route information, operation time information, or speed information before starting driving. In addition, the route information of the shuttle vehicle may be set by further considering the above-described operation time information or operation speed information and is not limited to the above-described embodiment.

However, for example, as described above, the autonomous driving shuttle vehicle travels along the guide line and thus may travel in consideration of recognition of the guide line. For example, when the autonomous driving shuttle vehicle operates in consideration of the above-described points, operation at an intersection may be set. In this case, for example, operation at the intersection may be performed by performing communication with the RSU, which will be described below.

Meanwhile, a user who wants to use a shuttle vehicle may use the shuttle device using a user-based moving object operation system according to an embodiment of the present disclosure.

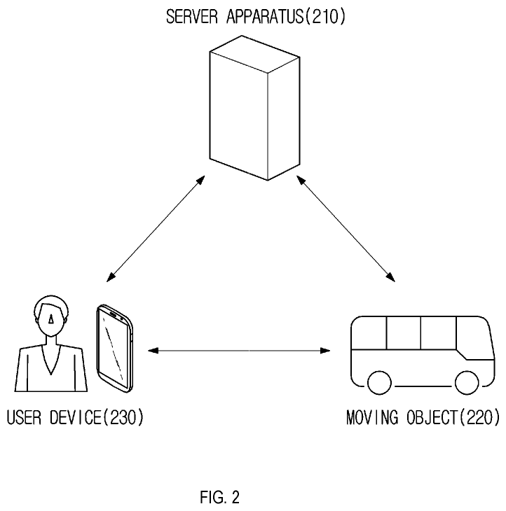

FIG. 2 is a view illustrating a user-based moving object operation system according to an embodiment of the present disclosure.

Referring to FIG. 2, the user-based moving object operation system according to an embodiment of the present disclosure may include a server apparatus 210 for performing a user-based moving object operation service, a moving object 220, and a user device 230.

The server apparatus 210 may control and manage overall operation of the user-based moving object operation service. For example, the server apparatus 210 may perform operation of managing the location of a moving object, operation of managing the usage status of the moving object, operation of managing profile information of a user, operation of managing usage information of the user or operation of providing the user with the location information or usage status of the moving object.

The moving object 220 may check riding of a user and perform personalized control according to the user riding therein. For example, the moving object 220 may identify the user using a device of the user, e.g., the user device 230, and request and receive profile information of the user from the server apparatus 210 based on a user ID. In this case, the user may be identified using a subscriber identification module (SIM). In addition, the moving object 220 may set the apparatus or facility of the moving object based on the usage information of the user. For example, the moving object 220 may set or control the posture of a seat on which the user is seated or set or control operation of an air conditioner provided at the location of the user.

In addition, the moving object 220 may check the profile information of the user riding therein and set and control an operation mode of the moving object based on the profile information. For example, the moving object 220 may check the age, gender, disability and mobility handicap information of the user and set and control the acceleration or deceleration control mode of the moving object.

Additionally, the moving object 220 may include a device for loading and fixing a personal mobility (PM) (hereinafter referred to as a “PM loading device”). For example, the personal mobility may include an electric scooter, a bicycle and an e-moped. The moving object 220 may generate and manage PM loading status information indicating whether the PM is loaded in the PM loading device, and provide the PM loading status information to the server apparatus 210. In response thereto, the server apparatus 210 may establish an environment in which the PM loading status information of each moving object is provided to a user through a service application. For example, the server apparatus 210 may provide the type of a PM capable of being loaded through the PM loading device provided in the moving object and the number of loadable PMs through a service application.

In addition, the moving object 220 may include a device for loading and fixing cargo (hereinafter referred to as a “cargo loading device”). The moving object 220 may generate and manage cargo loading status information indicating whether cargo is loaded on the cargo loading device, and provide the cargo loading status information to the server apparatus 210. For example, the moving object 220 may include a camera device for capturing an area in which the cargo loading device is located, and may include a cargo loading analyzer which analyzes an image captured through the camera device, checks a ratio of objects loaded on the cargo loading device, and outputs cargo loading status information including this. Meanwhile, the server apparatus 210, which has received the cargo loading status information, may establish an environment in which the cargo loading status information of each moving object is provided to a user through a service application. For example, the server apparatus 210 may provide the number of objects capable of being loaded in the moving object through the cargo loading device through a service application. Additionally, the moving object 220 may control operation of the moving object based on the cargo loading status information. For example, the moving object 220 may check the cargo loading status information and set and control the acceleration or deceleration control mode of the moving object.

Hereinafter, in an embodiment of the present disclosure, it is assumed that a moving object is a shuttle vehicle. Although, in this embodiment of the present disclosure, the operation of the user-based moving object operation system using a shuttle vehicle is exemplified, the present disclosure is not limited thereto and may be variously modified and applied to a moving object in which a plurality of users rides.

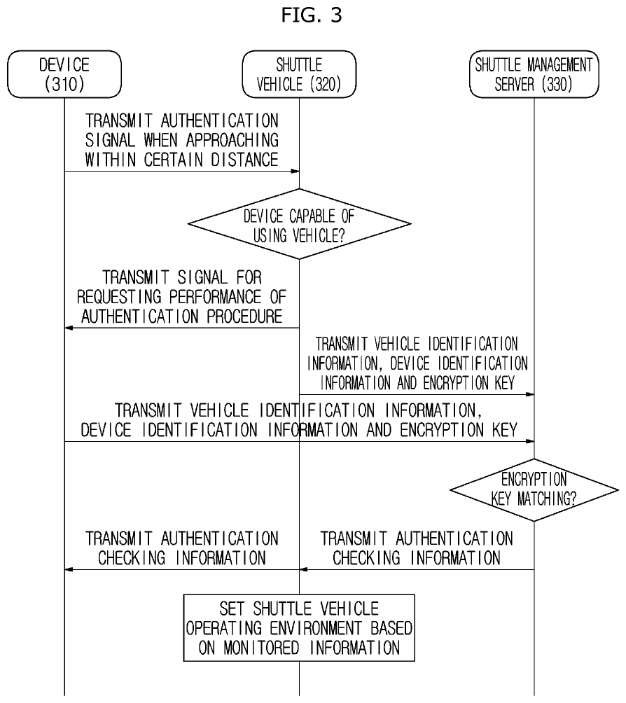

FIG. 3 is a view illustrating a method of using a shuttle vehicle according to an embodiment of the present disclosure.

Referring to FIG. 3, a device 310 may check information on a shuttle vehicle 320 through a shuttle management server (hereinafter referred to as a “server”)330. For example, the server 330 may provide information on the shuttle vehicle 320 which is being operated, location information of the shuttle vehicle, usage status information of the shuttle vehicle, PM loading status information, an estimated arrival time of each stop, and cargo loading status information. Specifically, the server 330 may establish a service application driving environment for providing the user-based moving object operation service, and a user may log in to the server 330 through a service application performed by the device 310. In response thereto, the user may select a predetermined shuttle vehicle through the device 310, and the server 330 may provide location information of the selected shuttle vehicle, usage status information (the number of remaining seats), PM loading status information (the number of remaining PM loading devices), estimated arrival time of each stop, and cargo loading status information through a service application.

In the above-described environment, a user who uses a personal mobility (PM) may check a shuttle vehicle to be used thereby through a service application and check PM loading status information to determine whether to use the shuttle vehicle. In addition, the user may check the PM loading status information, check a shuttle vehicle in which cargo is capable of being loaded, and use the shuttle vehicle according to the arrival time of the shuttle vehicle.

Meanwhile, the user may ride in the shuttle vehicle 320. In this case, the user may ride in the shuttle vehicle using the device 310 carried by the user. For example, in a state in which the user rides in the shuttle vehicle 320, the device 310 may approach the shuttle vehicle 320 within a predetermined distance. In this case, the device 310 may transmit an authentication signal to the shuttle vehicle 320. In addition, for example, the device 310 may use the shuttle vehicle 320 through communication with the shuttle vehicle. For example, the device 310 may check that the user approaches or rides in the shuttle vehicle 320 through UWB communication. The shuttle vehicle 320 may perform an authentication procedure from the server 330 when the device 310 approaches the shuttle vehicle 320, and the device 310 may approve riding in the shuttle vehicle 320. For example, when authentication for riding in the shuttle vehicle 320 is completed by the device 310, the entrance of the shuttle vehicle 320 may be opened. As another example, when authentication for riding in the shuttle vehicle 320 is completed by the device 310, the server 330 may process payment of the user through the device 310.

As another example, the device 310 may perform tagging for the shuttle vehicle based on NFC, Bluetooth, or a magnetic stripe of a transportation card. In this case, when the device 310 is tagged, the shuttle vehicle 320 may perform an authentication procedure from the server 330 and the device 310 may approve riding in the shuttle vehicle 320. For example, when authentication is completed based on the device tag, the server 330 may process payment of the user through the device 310.

Next, the shuttle vehicle 320 may monitor information on the user of the device 310 through UWB communication, and set the operating environment of the shuttle vehicle 320 based on the monitored information. Here, information on the user may include status information of the user.

Hereinafter, an operation of setting the operating environment of the shuttle vehicle 320 will be described.

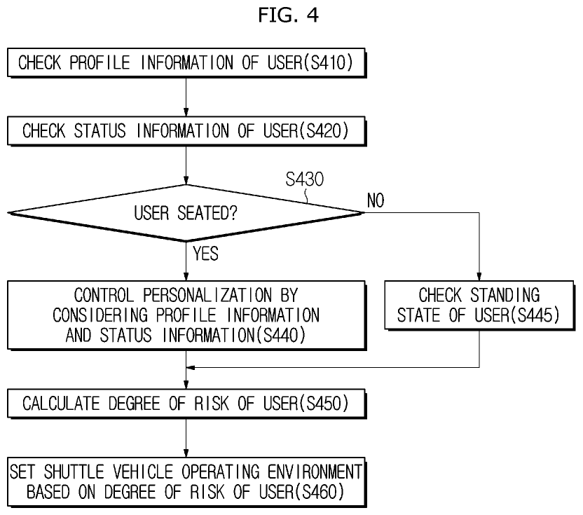

FIG. 4 is a flowchart illustrating a method of controlling a shuttle vehicle based on user according to an embodiment of the present disclosure.

Referring to FIG. 4, a shuttle vehicle may check profile information of a user through a server while the user rides in the shuttle vehicle (S410). For example, the shuttle vehicle may process an authentication procedure for riding through communication with a device while the user rides in the vehicle. In this case, the shuttle vehicle may check at least one of a device identifier or a user identifier through communication with a device carried by the user, and request and receive the profile information of the user from the server using the checked information. Here, the profile information of the user is the basis for operating environment setting and may include at least one of age, gender, health status, pregnancy status or disability status of the user. In addition, the profile information of the user may include personal setting information such as a seat posture setting value of the user or an air conditioner setting value.

Furthermore, the profile information of the user may include mobility handicap identification information indicating whether the user is mobility handicap. For example, the server apparatus may set and store a condition for determining the mobility handicap in advance. In addition, the server apparatus may determine whether the user is mobility handicap based on the age, gender, health status, pregnancy status or disability status of the user, and configure and store the mobility handicap identification information of each user based on this. Additionally, the server apparatus may set and store the condition for determining the type of the mobility handicap in advance. The server apparatus may configure the type of the mobility handicap based on the age, gender, health status, pregnancy status, or disability status of the user, and store and manage the type of the configured mobility handicap. For example, information such as mobility handicap identification information and the type of the mobility handicap may be included and managed in the profile information of the user.

Next, the shuttle vehicle may check status information of the user who rides in the vehicle (S420). For example, the shuttle vehicle may determine whether the user rides in a process of performing an authentication procedure for the device carried by the user. In this case, the shuttle vehicle may match a device identifier to a user and detect and monitor status information of the user based on a signal detected through UWB communication. For example, the status information of the user may include whether the user is seated. In this case, the shuttle vehicle may determine whether the user is seated by analyzing an image captured through a camera device provided in the shuttle vehicle (S430). In addition, the status information of the user may further include location information in the vehicle.

The shuttle vehicle may identify the location of the user and the seat on which the user is seated, by checking the status information of the user (S440). The shuttle vehicle may check personal setting information (e.g., a seat posture setting value, a seat temperature setting value, an air conditioner setting value, etc.) of information included in the profile information of the user and set a device provided in the shuttle vehicle according to the personal setting information. For example, the shuttle vehicle may check the seat posture setting value of the user and control the posture of the seat on which the user is seated according to the checked seat posture setting value. In addition, the shuttle vehicle may check the air conditioner setting value of the user and control the air conditioner of the seat, on which the user is seated, according to the checked air conditioner setting value. Additionally, the shuttle vehicle may further include a biometric information measurement device and detect and monitor the biometric information of the user measured by the biometric information measurement device. For example, the biometric information measurement device provided in the shuttle vehicle may include a thermal imaging camera, a body temperature sensor, a camera and the like. In addition, the biometric information of the user may include the body temperature of the user, the posture of the user and the like. In addition, in step S440, the shuttle vehicle may control settings of the device provided in the shuttle vehicle by further considering the biometric information of the user. For example, the shuttle vehicle may check body temperature information of the biometric information of the user and change the air conditioner setting value according to change in body temperature.

The shuttle vehicle may calculate a degree of risk of at least one user who rides in the vehicle (S450). The degree of risk of at least one user may be calculated based on the profile information of the user and the status information of the user. For example, a predetermined score may be given to each detailed item of the profile information of the user, that is, the age, gender, health status, pregnancy status or disability status of the user. In addition, a predetermined score may be given to each detailed item of the status information of the user, that is, whether the user is seated, location information, and the like. In this environment, the shuttle vehicle may calculate the degree of risk of the user by adding up the scores given to the detailed items of the profile information of the user and the detailed items of the status information of the user. As another example, a predetermined score may be given to each detailed item of the profile information of the user, that is, the age, gender, health status, pregnancy status or disability status of the user, and a weight may be given to the status information of the user, thereby calculating the degree of risk of the user.

Meanwhile, when the user is not seated, that is, when the user is in a standing state, the shuttle vehicle may check the standing posture information of the user (S445). Here, the standing posture information may include whether the user is holding an object (e.g., a bag, a PM, etc.) and whether the user hugs a person.

Thereafter, in step S450, the shuttle vehicle may calculate the degree of risk of a standing user who rides in the vehicle. For example, the degree of risk of at least one standing user may be calculated based on the profile information of the user and the standing posture information of the user. For example, a predetermined risk score may be given to each detailed item of the profile information of the user, that is, the age, gender, health status, pregnancy status or disability status of the user. In addition, a predetermined risk score may be given to the standing posture information of the user, that is, whether the user is holding an object (e.g., a bag, a PM, etc.) and whether the user hugs a person. In this environment, the shuttle vehicle may calculate the degree of risk of the user by adding up the detailed items of the profile information of the user and the risk score given to the standing posture information of the user. As another example, a predetermined risk score may be given to each detailed item of the profile information of the user, that is, the age, gender, health status, pregnancy status or disability status of the user, and a weight may be given to the standing posture information of the user, thereby calculating the degree of risk of the user.

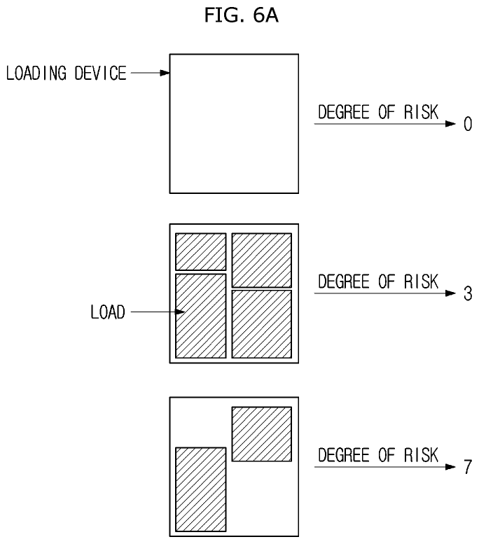

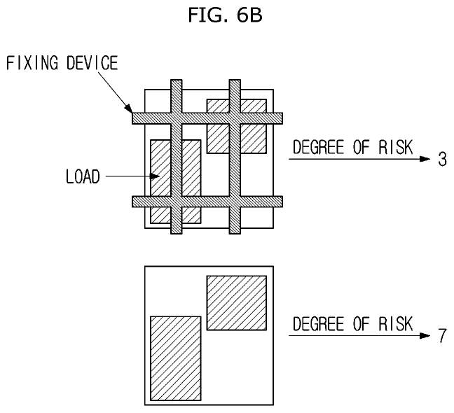

Furthermore, an operation of calculating the degree of risk of the user will be described in detail with reference to FIG. 6.

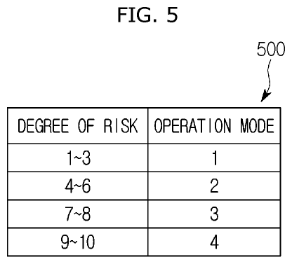

Thereafter, the shuttle vehicle may set the operation mode of the shuttle vehicle based on the above-described degree of risk (S460). For example, the operation mode matching the degree of risk may be determined and managed (see, e.g., table 500 of FIG. 5) and the operation mode of the shuttle vehicle may be set by checking the operation mode matching the degree of risk. Furthermore, the operation mode may include a value for controlling at least one of an acceleration/deceleration speed, a distance from a moving object traveling ahead, or a turning angle.

In addition, when the shuttle vehicle sets the operation mode, a highest degree of risk among degrees of risk of the user may be checked and the operation mode may be set based on the highest degree of risk. Furthermore, a cargo loading device in which cargo carried by the user is capable of being loaded may be provided in the shuttle vehicle, and a dangerous situation may occur to the user according to the state of the cargo loading device, that is, whether cargo is loaded on the cargo loading device or the cargo loading state. The operating environment of the shuttle vehicle is preferably set in consideration of whether cargo is loaded on the cargo loading device or the cargo loading state. For example, in step S450, the shuttle vehicle may further check the degree of risk based on the cargo loading information. In this case, the cargo loading information may include whether cargo is loaded and the cargo loading state. Here, the cargo loading state may include whether cargo is fixed to the loading device or the density of cargo loaded on the cargo loading device.

Furthermore, the shuttle vehicle may check the degree of risk of the cargo based on the cargo loading information. The degree of risk of the cargo may be calculated by digitizing the detailed items of the loading information. For example, in the shuttle vehicle, a state in which cargo is not loaded may be given a relatively lower score than a state in which cargo is loaded, and a relatively lower score may be given as the density of the cargo loaded on the loading device increases (see FIG. 6A). In addition, the shuttle vehicle may be set to give a relatively low score when the cargo is fixed to the loading device (see FIG. 6B).

In consideration of the above, the shuttle vehicle may set the operating environment by further considering the degree of risk of the cargo in step S460 of setting the operating environment.

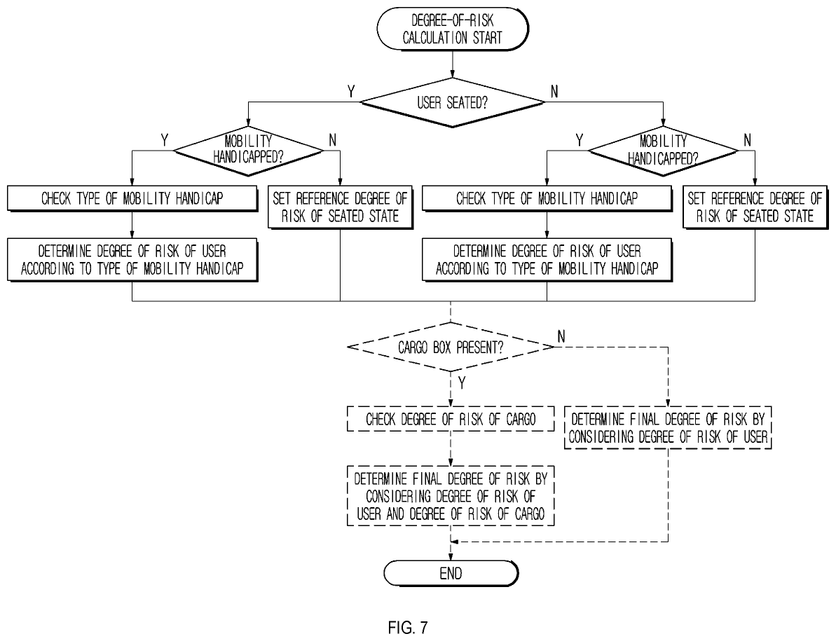

FIG. 7 is a flowchart illustrating detailed operation of step S450 of FIG. 4.

Referring to FIG. 7, the shuttle vehicle may check the status information of a user through step S420 and determine whether the user is seated.

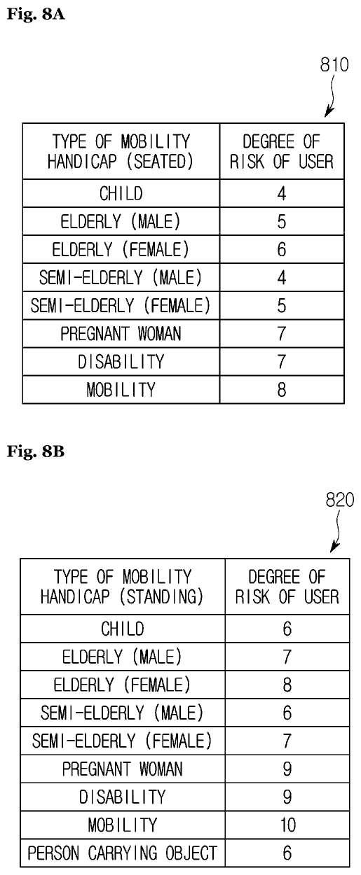

When the user is in a seated state, the shuttle vehicle may determine whether the user is mobility handicapped based on profile information. When the user is mobility handicapped, the shuttle vehicle may check the type of the mobility handicap and determine the degree of risk corresponding to the type of the mobility handicap. For example, the shuttle vehicle may store and manage a table 810 (see FIG. 8A) showing the degree of risk according to the type of the mobility handicap and check and determine the degree of risk according to the checked type of the mobility handicap. Meanwhile, when the user is not mobility handicapped, the shuttle vehicle may check a reference degree of risk which is basically set in the seated state and determine the reference degree of risk as a degree of risk of a user. For example, the reference degree of risk may be set to “1”.

Meanwhile, when the user is not in a seated state, that is, when the user is in a standing state, the shuttle vehicle may determine whether the user is mobility handicapped based on the profile information. When the user is mobility handicapped, the shuttle vehicle may check the type of the mobility handicap and determine the degree of risk corresponding to the type of the mobility handicap. For example, the shuttle vehicle may store and manage a table 820 (see FIG. 8B) showing the degree of risk according to the type of the mobility handicap and check and determine the degree of risk according to the checked type of the mobility handicap. Meanwhile, when the user is not mobility handicapped, the shuttle vehicle may check a reference degree of risk which is basically set in the standing state and determine the reference degree of risk as a degree of risk of a user. For example, the reference degree of risk may be set to “3”.

Additionally, the shuttle vehicle may include a cargo loading device and, in consideration of this, set the degree of risk by further considering the state of the cargo loading device.

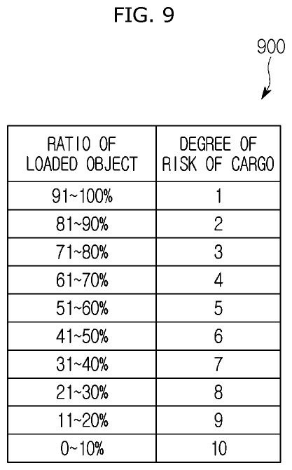

When there is a cargo loading device, the shuttle vehicle may further check a degree of risk of cargo. For example, the shuttle vehicle may analyze an image captured through a camera device for capturing an area in which the cargo loading device is present and check a ratio of objects loaded in the cargo loading device. In addition, the shuttle vehicle may determine the degree of risk of the cargo based on the ratio of the objects loaded in the cargo loading device. For example, the shuttle vehicle may store and manage a table (hereinafter referred to as a “cargo risk degree table”)900 (see FIG. 9) defining the degree of risk of cargo according to the object loading ratio, and check the degree of risk of cargo matching the object loading ratio by referring to the cargo risk degree table. Although, in an embodiment of the present disclosure, the degree of risk of cargo is checked using the cargo risk degree table 900, the present disclosure is not limited thereto and various methods of determining the degree of risk of cargo may be used in consideration of the object loading ratio.

Furthermore, the shuttle vehicle may determine a final degree of risk by considering the degree of risk of the cargo and the degree of risk of the user. For example, the final degree of risk may be determined by adding the degree of risk of the user to the degree of risk of the cargo. As another example, the final degree of risk may be calculated by giving a predetermined weight to the degree of risk of the user and the degree of risk of the cargo and adding the degree of risk of the user and the degree of risk of the cargo, to which the weight is given.

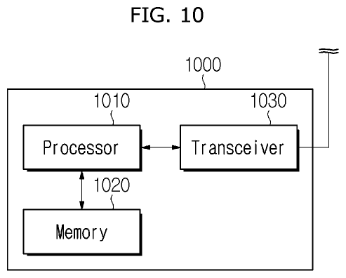

FIG. 10 is a view illustrating the configuration of an apparatus according to an embodiment of the present disclosure.

Referring to FIG. 10, the apparatus may include at least one of the above-described moving object, a device, a server and an RSU. In other words, the apparatus may be configured to communicate and work with another device. The present disclosure is not limited to the above-described embodiment. For example, for the above-described operation, an apparatus 1000 may include one or more among a processor 1010, a memory 1020, and a transceiver 1030. In other words, the apparatus may include a necessary configuration for communicating with another apparatus. In addition, the apparatus may include another configuration apart from the above-described configuration. In other words, the apparatus may have a configuration, which includes the above-described apparatus for communicating with another device but is not limited thereto, and may be operated based on what is described above.

Although the exemplary methods of the present disclosure described above are represented by a series of acts for clarity of explanation, they are not intended to limit the order in which the steps are performed, and if necessary, each step may be performed simultaneously or in a different order. In order to implement a method according to embodiments of the present disclosure, the illustrative steps may include an additional step or exclude some steps while including the remaining steps. Alternatively, some steps may be excluded while additional steps are included.

The various exemplary embodiments of the disclosure are not intended to be all-inclusive and are intended to illustrate representative aspects of the disclosure, and the features described in the various exemplary embodiments may be applied independently or in a combination of two or more. In addition, the various exemplary embodiments of the present disclosure may be implemented by hardware, firmware, software, or a combination thereof. In the case of hardware implementation, one or more application specific integrated circuits (ASICs), digital signal processors (DSPs), digital signal processing devices (DSPDs), programmable logic devices (PLDs), field programmable gate arrays, a general processor, a controller, a microcontroller, a microprocessor, and the like may be used for implementation.

The scope of the present disclosure includes software or machine-executable instructions (for example, an operating system, applications, firmware, programs, etc.) that enable operations according to the methods of various exemplary embodiments to be performed on a device or computer, and a non-transitory computer-readable medium in which such software or instructions are stored and are executable on a device or computer.

What is claimed is:

1. A method of controlling a moving object, the method comprising:
checking profile information of a user who rides in the moving object or status information of the user;
checking a degree of risk based on the profile information or the status information of the user;
setting an operation mode of the moving object based on the degree of risk; and
controlling movement of the moving object based on the operation mode.

2. The method of claim 1, wherein the status information of the user comprises whether the user is seated or a location of the user in the moving object.

3. The method of claim 1, wherein the profile information comprises age, gender, health status, pregnancy status, disability status, or personal setting information of the user.

4. The method of claim 1, wherein the operation mode of the moving object comprises a value for controlling an acceleration/deceleration speed, a distance from a moving object traveling ahead, or a turning angle.

5. The method of claim 1, wherein checking the degree of risk comprises checking the degree of risk of the user using the profile information of the user or the status information of the user.

6. The method of claim 1, wherein checking the degree of risk comprises checking a highest degree of risk among degrees of risk of the user.

7. The method of claim 1, wherein checking the degree of risk comprises checking a seated or standing state of the user and checking whether the user is mobility handicap.

8. The method of claim 7, wherein checking the degree of risk comprises:
checking a type of mobility handicap of the user; and
checking the degree of risk corresponding to the type of mobility handicap.

9. The method of claim 8, wherein checking the type of mobility handicap of the user comprises checking the type of mobility handicap of the user based on the profile information of the user.

10. The method of claim 9, wherein checking the degree of risk comprises checking standing posture information of the user.

11. The method of claim 10, wherein checking the degree of risk comprises determining the degree of risk by determining a first degree of risk corresponding to the type of mobility handicap of the user and a second degree of risk corresponding to the standing posture information.

12. The method of claim 11, wherein checking the degree of risk comprises adding the first degree of risk corresponding to the type of mobility handicap of the user and the second degree of risk corresponding to the standing posture information.

13. The method of claim 10, wherein checking the degree of risk comprises determining the degree of risk by giving a weight corresponding to the standing posture information to the degree of risk corresponding to the type of mobility handicap of the user.

14. The method of claim 1, further comprising controlling a riding environment of the moving object based on the profile information of the user, wherein the riding environment of the moving object comprises a seat posture setting value, a seat temperature setting value, or an air conditioner setting value.

15. The method of claim 1, further comprising checking loading information of cargo loaded on a cargo loading device provided in the moving object.

16. The method of claim 15, wherein the loading information of the cargo comprises information indicating whether the cargo is loaded, information indicating whether the cargo is fixed, or information indicating density of the cargo loaded on the cargo loading device.

17. The method of claim 16, wherein checking the degree of risk further comprises determining a final degree of risk based on the degree of risk of the user and a degree of risk of the cargo.

18. The method of claim 1, further comprising:
checking loading state information of a personal mobility; and
providing the loading state information of the personal mobility to a preliminary user who will ride in the moving object.

19. A moving object in a moving object control system, the moving object comprising:
a communication device;
at least one storage medium; and
at least one processor configured to:
determine profile information of a user who rides in the moving object or status information of the user;
determine a degree of risk based on the profile information or the status information of the user;
set an operation mode of the moving object based on the degree of risk; and
control movement of the moving object based on the operation mode.

20. A server in a moving object control system, the server comprising:
a communication device;
at least one storage medium; and
at least one processor connected to a moving object provided in a moving object operation system and to a user device, wherein the processor is configured to:
provide a moving object operation service; and
manage profile information of a user who uses the moving object operation service, usage information of the user, location information of the moving object, or usage status information of the moving object.
